(19) United States
(12) Patent Application Publication
(10) Pub. No.: US 2018/0058514 A1
(43) Pub. Date: Mar. 1, 2018

(54) SYNCHRONIZING DEVICE AS WELL AS A GEAR CHANGING TRANSMISSION FOR A VEHICLE

(71) Applicant: OERLIKON FRICTION SYSTEMS (GERMANY) GMBH, Bremen (DE)

(72) Inventors: Ulf CHRISTOFFER, Bremen (DE); Nils WEBER, HANNOVER (DE); Marcus SPRECKELS, Oyten (DE)

(73) Assignee: OERLIKON FRICTION SYSTEMS (GERMANY) GMBH, Bremen (DE)

(21) Appl. No.: 15/683,122

(22) Filed: Aug. 22, 2017

(30) Foreign Application Priority Data
Aug. 23, 2016 (EP) 16185389.0

(51) Int. Cl. F16D 23/02; F16D 69/02

(52) U.S. Cl. CPC F16D 23/025; F16D 69/02

(57) ABSTRACT

Synchronizing device (1) of a gear changing transmission for a motor vehicle. The synchronizing device (1) of a gear changing transmission for a motor vehicle including an inner synchronizer ring (2), a middle synchronizer ring (3) and an outer synchronizer ring (4). The middle synchronizer ring (3) includes a first conical middle ring body (301) with a first inner surface of the middle ring (3011) and a first outer surface of the middle ring (3012), which each bound the first middle ring body (301) in a radial direction extending to the axial ring axis (8), wherein the first inner surface of the middle ring (3011) extends at a first inner angle (α₃₀₁₁) of the middle ring and the first outer surface of the middle ring (3012) at a first outer angle (α₃₀₁₂) of the inner ring to the ring axis (8). In order to further increase the synchronizing moment to be transmitted the first inner angle (α₃₀₁₁) of the middle ring and the first outer angle (α₃₀₁₂) of the middle ring are different according to the invention.

### CROSS-REFERENCE TO RELATED APPLICATIONS

The present application claims priority under 35 U.S.C. §119(a) of European Patent Application No. EP 161 85 389.0 filed Aug. 23, 2016, the disclosure of which is expressly incorporated by reference herein in its entirety.

### BACKGROUND OF THE INVENTION

### 1. Field of the Invention

The invention relates to a synchronizing device for a gear changing transmission according to the preamble of the independent claim 1. The invention further relates to a gear changing transmission for a vehicle according to the independent claim 12.

### 2. Discussion of Background Information

From DE 199 28 597 and EP 1 312 823 A1 a generic synchronizing device for a gear changing transmission of a vehicle is known from the state of the art. Such a triple synchronizing device comprises an outer synchronizer ring, a middle synchronizer ring and an inner synchronizer ring. In operating mode the outer synchronizer ring and the inner synchronizer ring are connected essentially torque proof with a first shifting element, and the middle synchronizer ring is connected essentially torque proof with a second shifting element, which is designed as a gear wheel to be shifted. The middle synchronizer ring comprises a first conical middle ring body having a first inner surface of the middle ring and a first outer surface of the middle ring, which each bound the first middle ring body in a radial direction extending to an axial ring axis. The first inner surface of the middle ring extends at a first inner angle of the middle ring and the first outer surface of the middle ring extends at a first outer angle of the middle ring to the ring axis, the first inner angle of the middle ring and the first outer angle of the middle ring being the same size, i.e. the first inner surface of the middle ring and the first outer surface of the middle ring are parallel to each other. The outer and the inner synchronizer ring are designed and arranged in such a way, that the first inner surface of the middle ring interacts with the inner synchronizer ring and the first outer surface of the middle ring directly interacts with the outer synchronizer ring during a synchronization process, wherein the outer and the inner synchronizer ring are displaced in direction to the gear wheel to be synchronized.

The synchronizing devices according to the two documents mentioned above, both having a synchronizer ring, comprising a conical inner ring body with a inner surface of the inner ring and a outer surface of the inner ring, which each bound the inner ring body in a radial direction extending to the axial ring axis. Whereby the inner surface of the inner ring extends at an inner angle of the inner ring and the outer surface of the inner ring at a outer angle of the inner ring to the ring axis. The difference between the two versions is, that in the case of the synchronizing device of DE 199 28 597 the inner surface of the inner ring and the outer surface of the inner ring are arranged parallel to each other whereas in the case of the synchronizing device of EP 1 312 823 A1 the inner angle of the inner ring is larger than the outer angle of the inner ring, i.e. the inner surface of the inner ring and the outer surface of the inner ring are not parallel to each other. Hereby it is achieved, in contrast to the synchronizing device of DE 199 28 597, that in the event of incorrect operating the synchronizing device, i.e. particularly during long-lasting pre-synchronizing of a gear with corresponding heat development, the service life of the synchronizing device is improved.

The problem, already known from single synchronizing devices and described in EP 2677187 A1, between achieving a high shifting capacity with simultaneous high shifting convenience is, of course, also present regarding the triple synchronizing device shown above. This problem leads to a high shifting capacity, i.e. the transmission of a high synchronizing moment at a low shifting force by a small cone angle of the friction combination. But the self-locking effect preventing loosening of the friction surfaces and substantially and noticeable affecting the shifting convenience of the driver sets a limit to the minimization of the cone angle.

Compared to a dual synchronizing device, both the synchronizing device according to DE 199 28 597 and EP 1 312 823 A1 enable the transmission of a higher synchronizing moment at an acceptable shifting quality. However, increased requirements to the shifting capacity are imposed with respect to a novel triple synchronizing device, shifting quality and installation space remaining the same.

### SUMMARY OF THE EMBODIMENTS

Thus, the object of the invention is providing a multiple synchronizing device, by means of which the shifting capacity can be increased with the same shifting quality and without an increased installation space.

The objects of the invention solving this problem are characterized by the features of the independent claim 1.

The dependent claims relate to particularly advantageous embodiments of the invention.

Hence the invention relates to a synchronizing device for a gear changing transmission, comprising an outer synchronizer ring, a middle synchronizer ring and an inner synchronizer ring. Though the middle synchronizer ring comprises at least a first conical middle ring body having a first inner surface of the middle ring and a first outer surface of the middle ring, which each bound the first middle ring body in a radial direction extending to an axial ring axis. The first inner surface of the middle ring extends at a first inner angle of the middle ring and the first outer surface of the middle ring at a first outer angle of the middle ring to the ring axis.

According to the invention, the first inner angle of the middle ring and the first outer angle of the middle ring are different, i.e. the synchronizing device has at least a small angle at the middle synchronizer ring which contributes to the transmission of a high synchronizing moment having a positive effect on the shifting quality and the installation space. At the same time, the synchronizing device has a large angle at the middle synchronizer ring, which contributes to the loosening of the inner and outer synchronizer ring. Hereby the self-locking is minimized having a positive effect on the shifting quality.

Within the framework of this invention the “operating mode” represents the state of the synchronizing process, wherein the outer and the inner synchronizer ring are displaced in direction to the gear wheel to be synchronized. In the operating mode the outer and the inner synchronizer ring are in friction contact with the middle synchronizer ring and thereby friction-locked generating a synchronizing moment.

Additionally, within the framework of this invention the term “loosening” means the transmission of the synchronizing device from the operating mode to a non-operating mode, the non-operating mode representing the state of the synchronizing process, wherein the outer and the inner synchronizer ring are displaced away from the gear wheel to be synchronized, i.e. that they are not engaged with the middle synchronizer ring and that they substantially not transmit any synchronizing moment.

In order to get from the non-operating mode to the operating mode and vice versa, the inner, middle and outer synchronizer ring have the following different types of surfaces: friction surface, loosening surface and friction/loosening surface. A friction surface extends at a small angle, particularly at an angle of 3°-5° to the axial ring axis and serves only for transmitting the synchronizing moment and dissipates the friction energy arising by the conversion of the kinetic energy. A loosening surface extends at a large angle, particularly at an angle of 6°-9° to the axial ring axis and serves only for loosening. No appreciable relative movement takes place between the contacting surfaces. A friction/loosening surface extends at a large angle to the axial ring axis and serves for transmitting the synchronizing moment as well as for loosening.

Within the framework of this invention a functional friction surface is to be understood as a friction surface or as a friction/loosening surface. Within the framework of this invention a functional loosening surface is to be understood as a loosening surface or as a friction/loosening surface.

Preferably, but not necessarily, the first inner angle of the middle ring can be smaller than the first outer angle of the middle ring.

Regarding an embodiment, which is very important in practice, the middle synchronizer ring is made of the first conical middle ring body and a second conical middle ring body. The second middle ring body comprising a second inner surface of the middle ring and a second outer surface of the middle ring, which each bound the second middle ring body in a radial direction extending to the axial ring axis. The second inner surface of the middle ring extends at a second inner angle of the middle ring and the second outer surface of the middle ring at a second outer angle of the middle ring to the ring axis, wherein the second inner angle of the middle ring the first outer angle of the middle ring. In the operating mode, the second inner surface of the middle ring is in contact with the first outer surface of the middle ring and the second outer surface of the middle ring interacts with the outer synchronizer ring.

Due to the two-piece design of the middle synchronizer ring an additional loosening surface is established facilitating the loosening at the transition from the operating mode to the non-operating mode.

In a preferred embodiment, the inner synchronizer ring is made of a first conical inner ring body and a second conical inner ring body, the first inner ring body comprising a first inner surface of the inner ring and a first outer surface of the inner ring, which each bound the first inner ring body in a radial direction extending to the axial friction ring axis, wherein the first inner surface of the inner ring extends at first inner angle of the inner ring and the first outer surface of the inner ring at a first outer angle of the inner ring to the friction ring axis, and the second inner ring body comprising a second inner surface of the inner ring and a second outer surface of the inner ring, which each bound the second inner ring body in a radial direction extending to the axial friction ring axis, wherein the second inner surface of the inner ring extends at a second inner angle of the inner ring and the second outer surface of the inner ring at a second outer angle of the inner ring to the friction ring axis, wherein the second inner angle of the inner ring the first outer angle of the inner ring and in the operating mode, the first inner surface of the inner ring interacts with the second shifting element, the second inner surface of the inner ring is in contact with the first outer surface of the inner ring and the second outer surface of the inner ring interacts with the first inner surface of the middle ring.

The two-piece design of the inner synchronizer ring results in an additional loosening surface, thereby facilitating the loosening at the transition from the operating mode to the non-operating mode.

It also proved to be advantageous the synchronizing device comprising an intermediate synchronizer ring with a conical intermediate ring body, wherein the intermediate ring body comprising an inner surface of the intermediate ring and an outer surface of the intermediate ring, which each bound the intermediate ring body in a radial direction extending to the axial friction ring axis, wherein the inner surface of the intermediate ring extends at an inner angle of the intermediate ring and the outer surface of the intermediate ring at an outer angle of the intermediate ring to the friction ring axis, wherein the intermediate synchronizer ring is arranged between the outer synchronizer ring and the middle synchronizer ring and is connected torque proof with the inner synchronizer ring and the outer synchronizer ring, wherein the inner angle of the intermediate ring corresponds to the first outer angle of the middle ring and the outer angle of the intermediate ring corresponds to an inner angle of the outer ring, so that in the operating mode the inner surface of the intermediate ring is form-locking connected, at least partially, to the first outer surface of the middle ring and the outer surface of the intermediate ring interacts with the outer synchronizer ring.

The intermediate synchronizer ring results in an additional loosening surface, thereby facilitating the loosening at the transition from the operating mode to the non-operating mode.

It is also advantageous for transmitting a high synchronizing moment, if the first inner angle of the inner ring and/or the first outer angle of the inner ring and/or the second outer angle of the inner ring and/or the first inner angle of the middle ring and/or the first outer angle of the middle ring and/or the second outer angle of the middle ring and/or the inner angle of the intermediate ring and/or the outer angle of the intermediate ring is 3-5°.

In order to ensure a secure transmission of the synchronizing device from the operating mode to the non-operating mode it is also advantageous if the first inner ring body and/or the second inner ring body and/or the first middle ring body and/or the second middle ring body and/or the intermediate ring body has a cutoff in a circumferential direction extending to the axial ring axis. The cutoff is open or closed in the non-operating mode.

It also proved to be advantageous in practice, the first inner ring body and/or the second inner ring body and/or the first middle ring body and/or the second middle ring body and/or the intermediate ring body having at least one limit stop for axial fixing in direction to the ring axis.

It is also proved to be advantageous for transmitting a high synchronizing moment if a friction layer, especially a friction layer in the form of a carbon friction layer is provided at the first inner surface of the inner ring and/or at the first outer surface of the inner ring and/or at the second inner surface of the inner ring and/or at the second outer surface of the inner ring and/or at the first inner surface of the middle ring and/or at the first outer surface of the middle ring and/or at the second inner surface of the middle ring and/or at the second outer surface of the middle ring and/or at the inner surface of the intermediate ring and/or at the outer surface of the intermediate ring.

Finally, it is advantageous providing an adhesion reducing surface structure at the first inner surface of the inner ring and/or at the first outer surface of the inner ring and/or at the second inner surface of the inner ring and/or at the second outer surface of the inner ring and/or at the first inner surface of the middle ring and/or at the first outer surface of the middle ring and/or at the second inner surface of the middle ring and/or at the second outer surface of the middle ring and/or at the inner surface of the intermediate ring and/or at the outer surface of the intermediate ring. Hereby a secure transmission of the synchronizing device from the operating mode to the non-operating mode is ensured.

### BRIEF DESCRIPTION OF THE DRAWINGS

The invention is explained in more detail below with reference to the schematic drawing. It is shown:

FIG. 1 a cross-section of a synchronizing device known from the state of the art;

FIG. 2a a cross-section of a first embodiment of a synchronizing device according to the invention having two functional friction surfaces;

FIG. 2b a cross-section of a second embodiment of a synchronizing device according to the invention having two functional friction surfaces;

FIG. 2c a cross-section of a third embodiment of a synchronizing device according to the invention having two functional friction surfaces;

FIG. 2d a cross-section of a fourth embodiment of a synchronizing device according to the invention having two functional friction surfaces;

FIG. 3a a cross-section of a first embodiment of a synchronizing device according to the invention having three functional friction surfaces;

FIG. 3b a cross-section of a second embodiment of a synchronizing device according to the invention having three functional friction surfaces;

FIG. 3c a cross-section of a third embodiment of a synchronizing device according to the invention having three functional friction surfaces;

FIG. 3d a cross-section of a fourth embodiment of a synchronizing device according to the invention having three functional friction surfaces;

FIG. 3e a cross-section of a fifth embodiment of a synchronizing device according to the invention having three functional friction surfaces;

FIG. 3f a cross-section of a sixth embodiment of a synchronizing device according to the invention having three functional friction surfaces;

### DETAILED DESCRIPTION OF THE EMBODIMENTS

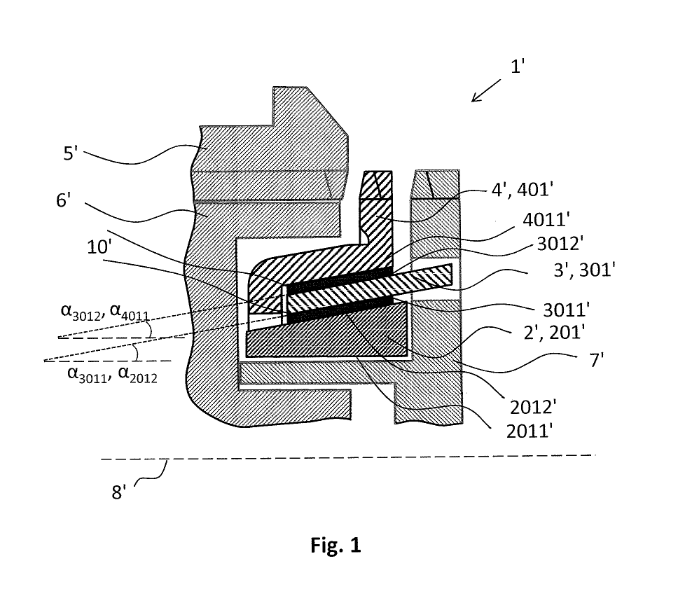

In the following it is referred to FIG. 1 to explain a synchronizing device known from the state of the art. In order to distinguish the state of the art from the present invention the reference signs referring to features of a synchronizing device known from the state of the art have an inverted comma, while features of embodiments according to the invention have reference sign without an inverted comma.

FIG. 1 shows a cross-section of a synchronizing device 1′ known from the state of the art comprising an inner synchronizer ring 2′, a middle synchronizer ring 3′ and an outer synchronizer ring 4′. In a manner known per se the synchronizing device 1′ also has a sliding sleeve 5′ with a synchronizer body 6′ and a gear wheel 7′. The outer synchronizer ring 4′ and the inner synchronizer ring 2′ are connected essentially torque proof with the synchronizer body 6′ and the middle synchronizer ring 3′ is connected essentially torque proof with the gear wheel 7′. The components mentioned above are coaxially arranged to a ring axis 8′ in such a way, the inner synchronizer ring 2′ and the outer synchronizer ring 4′ being displaceable together along the ring axis 8′ in direction to the gear wheel 7′ by the sliding sleeve 5′ during the synchronizing process, so that the inner synchronizer ring 2′ and the outer synchronizer ring 4′ can be engaged with the gear wheel 7′.

The middle synchronizer ring 3′ also comprises a first conical middle ring body 301′ having a first inner surface of the middle ring 3011′ and a first outer surface of the middle ring 3012′, which each bound the first middle ring body 301′ in a radial direction extending to the radial ring axis 8′. The first inner surface of the middle ring 3011′ extends at a first inner angle α_{3011′} of the middle ring and the first outer surface of the middle ring 3012′ extends at a first outer angle α_{3012′} of the middle ring to the ring axis 8′, wherein the first inner angle α_{3011′} of the middle ring and the first outer angle α_{3012′} of the middle ring are the same size, i.e. the first inner surface of the middle ring 3011′ and the first outer surface of the middle ring 3012′ are parallel to each other.

The inner synchronizer ring 2′ comprises a first conical inner ring body 201′ having a first inner surface of the inner ring 2011′ and a first outer surface of the inner ring 2012′, which each bound the first inner ring body 201′ in the radial direction extending to the radial ring axis 8′. The first inner surface of the inner ring 2011′ extends at a first inner angle α_{2011′} of the inner ring and the first outer surface of the inner ring 2012′ extends at a first outer angle α_{2012′} of the inner ring to the ring axis 8′, wherein the first inner angle α_{2011′} of the inner ring is 0° and the first outer angle of the inner ring α_{2012′} is the same size as the first inner angle α_{3011′} of the middle ring.

The outer synchronizer ring 4′ comprises an outer ring body 401′ having an inner surface of the outer ring 4011′, extending at an inner angle α_{4011′} of the outer ring to the ring axis 8′, the inner angle α_{4011′} of the outer ring being the same size as the first outer angle α_{3012′} of the middle ring.

Thus, the inner and the outer synchronizer ring 2′, 4′ are designed and arranged, that the first inner surface of the middle ring 3011′ is in friction contact with the first outer surface of the inner ring 2012′ and the first outer surface of the middle ring 3012′ is directly in friction contact with the inner surface of the outer ring 4011′ during a synchronization process when displacing the inner and the outer synchronizer ring 2′, 4′ in direction to the gear wheel 7′ to be synchronized. For this purpose, the surfaces being in friction contact have a friction layer 10′, namely the first outer surface of the inner ring 2012′ and the first inner surface of the middle ring 3011′ or the first outer surface of the middle ring 3012′ and the inner surface of the outer ring 4011′, respectively. In order to ensure a secure transmission of the synchronizing device from the operating mode to the non-operating mode the first inner angle α_{3011′} of the middle ring and the first outer angle α_{3012′} of the middle ring are large angles. I.e. the synchronizing device according to the state of the art is a configuration of a synchronizing device with two friction/loosening surfaces.

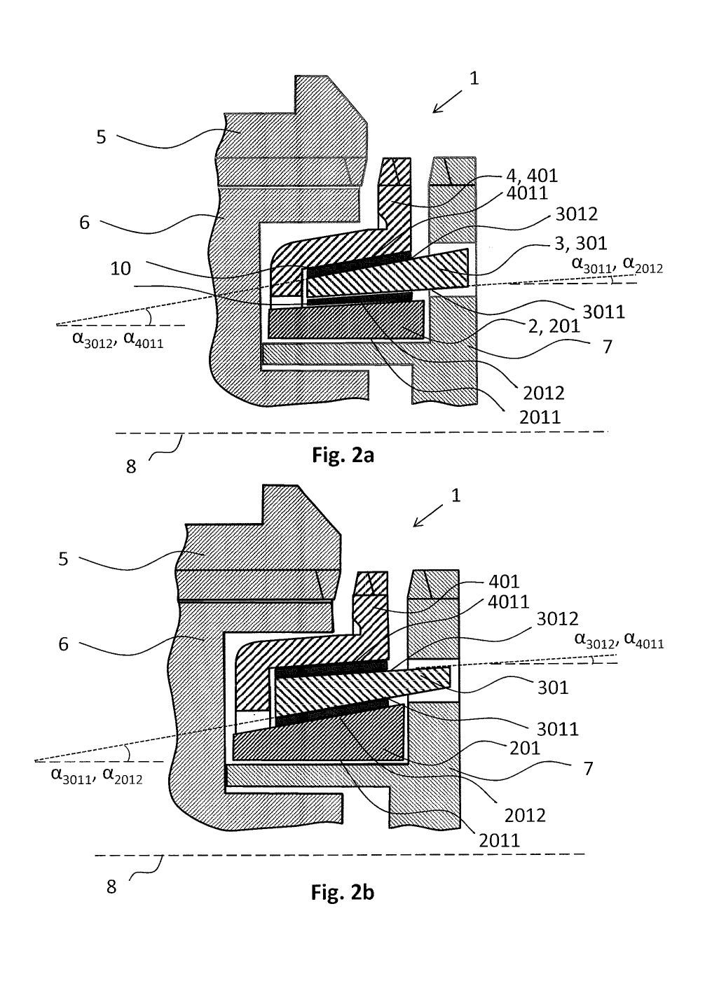

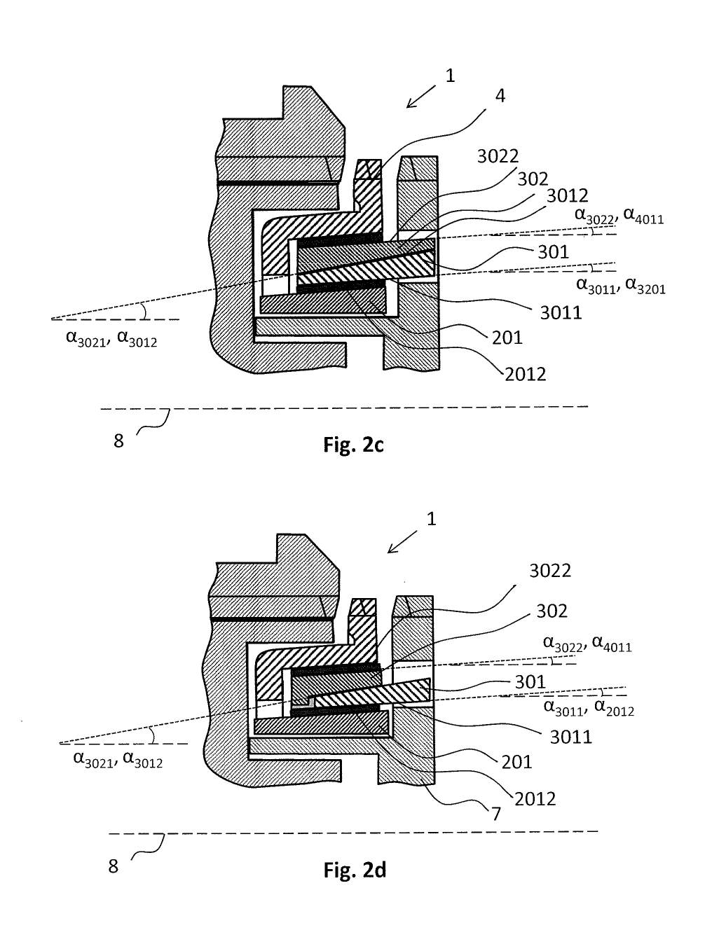

FIG. 2a shows a cross-section of a first embodiment of a synchronizing device according to the invention 1 having two functional friction surfaces.

The synchronizing device 1 comprises an inner synchronizer ring 2, a middle synchronizer ring 3 and an outer synchronizer ring 4. The synchronizing device 1 also has a sliding sleeve 5 with a synchronizing body 6 and a gear wheel 7 as already described above with reference to FIG. 1. The outer synchronizer ring 4 and the inner synchronizer ring 2 are connected essentially torque proof with the synchronizing body 6 and the middle synchronizer ring 3 is connected essentially torque proof with the gear wheel 7. The components mentioned above are coaxially arranged to a ring axis 8 in such a way, the inner synchronizer ring 2 and the outer synchronizer ring 4 being displaceable together along the ring axis 8 in direction to the gear wheel 7 by the sliding sleeve 5 during the synchronizing process, so that the inner synchronizer ring 2 and the outer synchronizer ring 4 can be engaged with the gear wheel 7.

The middle synchronizer ring 3 comprises a first conical middle ring body 301 having a first inner surface of the middle ring 3011 and a first outer surface of the middle ring 3012, which each bound the first middle ring body 301 in a radial direction extending to the radial ring axis 8. The first inner surface of the middle ring 3011 extends at a first inner angle α₃₀₁₁ of the middle ring and the first outer surface of the middle ring 3012 extends at a first outer angle α₃₀₁₂ of the middle ring to the ring axis 8, wherein in contrast to the synchronizing device 1 from the state of the art (FIG. 1) the first inner angle α₃₀₁₁ of the middle ring and the first outer angle α₃₀₁₂ of the middle ring are different, i.e. the first inner surface of the middle ring 3011 and the first outer surface of the middle ring 3012 are not parallel. In this embodiment the first inner angle α₃₀₁₁ of the middle ring is 3° and the first outer angle α₃₀₁₂ of the middle ring is 7°.

The inner synchronizer ring 2 comprises a first conical inner ring body 201 having a first inner surface of the inner ring 2011 and a first outer surface of the inner ring 2012, which each bound the first inner ring body 201 in the radial direction extending to the axial ring axis 8. The first inner surface of the inner ring 2011 extends at a first inner angle α₂₀₁₁ of the inner ring and the first outer surface of the inner ring 2012 extends at a first outer angle α₂₀₁₂ of the inner ring to the ring axis 8, wherein the first inner angle α₂₀₁₁ of the inner ring is 0° and the first outer angle of the inner ring α₂₀₁₂ is the same size as the first inner angle of the middle ring α₃₀₁₁.

The outer synchronizer ring 4′ comprises an outer ring body 401′ having an inner surface of the outer ring 4011′, extending at an inner angle α_{4011′} of the outer ring to the ring axis 8′, the inner angle α_{4011′} of the outer ring being the same size as the first outer angle α_{3012′} of the middle ring.

Thus, the inner and the outer synchronizer ring 2, 4 are designed and arranged, that the first inner surface of the middle ring 3011 is in friction contact with the first outer surface of the inner ring 2012 and the first outer surface of the middle ring 3012 is directly in friction contact with the inner surface of the outer ring 4011 during a synchronization process when displacing the inner and the outer synchronizer ring 2, 4 in direction to the gear wheel 7 to be synchronized. For this purpose, the surfaces being in friction contact have a friction layer 10, namely the first outer surface of the inner ring 2012 and the first inner surface of the middle ring 3011 or the first outer surface of the middle ring 3012 and the inner surface of the outer ring 4011, respectively.

This first embodiment of the synchronizing device 1 according to the invention is characterized in that it has a friction surface, i.e. a surface extending at a small angle to the axial ring axis 8 and serving only for transmitting the synchronizing moment, and it has one friction/loosening surface extending at a large angle to the axial ring axis 8 and serving for transmitting the synchronizing moment as well as for loosening. Thus, an increased synchronizing moment can be transmitted with the same shifting quality compares to the state of the art.

FIG. 2b shows a cross-section of a second embodiment of a synchronizing device 1 according to the invention having two functional friction surfaces. In contrast to the synchronizing device 1 from FIG. 2a the first inner angle α₃₀₁₁ of the middle ring is large (7°) and the first outer angle α₃₀₁₂ of the middle ring is small (3°). According to this the outer angle α₂₀₁₂ of the inner ring is large and the inner angle α₄₀₁₁ of the outer ring is small.

As the embodiment in FIG. 2a this embodiment also has a friction surface and a friction/loosening surface.

FIG. 2c shows a cross-section of a third embodiment of a synchronizing device 1 according to the invention having two functional friction surfaces. In contrast to the synchronizing device 1 from FIGS. 2a and 2b the synchronizing device 1 according to FIG. 2c has a two-piece middle synchronizer ring 3, i.e. the middle synchronizer ring 3 is made of a first conical middle ring body 301 and a second conical middle ring body 302. The second middle ring body 302 comprising a second inner surface of the middle ring 3021 and a second outer surface of the middle ring 3022 which each bound the second middle ring body 302 in the radial direction extending to the axial friction ring axis 8. The second inner surface of the middle ring 3021 extends at a second inner angle α₃₀₂₁ of the middle ring and the second outer surface of the middle ring 3022 at a second outer angle α₃₀₂₂ of the middle ring to the ring axis 8. Thereby the second inner angle α₃₀₂₁ of the middle ring corresponds to the first outer angle α₃₀₁₂ of the middle ring and the second outer angle α₃₀₂₂ of the middle ring to the first inner angle α₃₀₁₁ of the middle ring. In the operating mode the second inner surface of the middle ring 3021 is form-locking connected to the first outer surface of the middle ring 3012 and the second outer surface of the middle ring 3022 interacts with the outer synchronizer ring 4.

In this embodiment the first inner angle α₃₀₁₁ of the middle ring and the second outer angle α₃₀₂₂ of the middle ring are small, whereas the first outer angle α₃₀₁₂ of the middle ring and the second inner angle α₃₀₂₁ of the middle ring are large.

Thus, the synchronizing device 1 according to FIG. 2c has two friction surfaces and one loosening surface.

FIG. 2d shows a cross-section of a fourth embodiment of a synchronizing device 1 according to the invention having two functional friction surfaces.

In contrast to the synchronizing device 1 according to FIG. 2c, in the synchronizing device 1 according to FIG. 2d the second middle ring body 302 is connected essentially torque proof with the gear wheel 7 via the first middle ring body 301. Thus, in contrast to the synchronizing device 1 according to FIG. 2c the second inner surface of the middle ring 3021 is form-locking connected, only partially, to the first outer surface of the middle ring 3012 in the operating mode.

As shown in the embodiment according to FIG. 2c, the first inner angle α₃₀₁₁ of the middle ring and the second outer angle α₃₀₂₂ of the middle ring are small, whereas the first outer angle α₃₀₁₂ of the middle ring and the second inner angle α₃₀₂₁ of the middle ring are large in this embodiment.

Thus, the synchronizing device 1 according to FIG. 2d has two friction surfaces and one loosening surface.

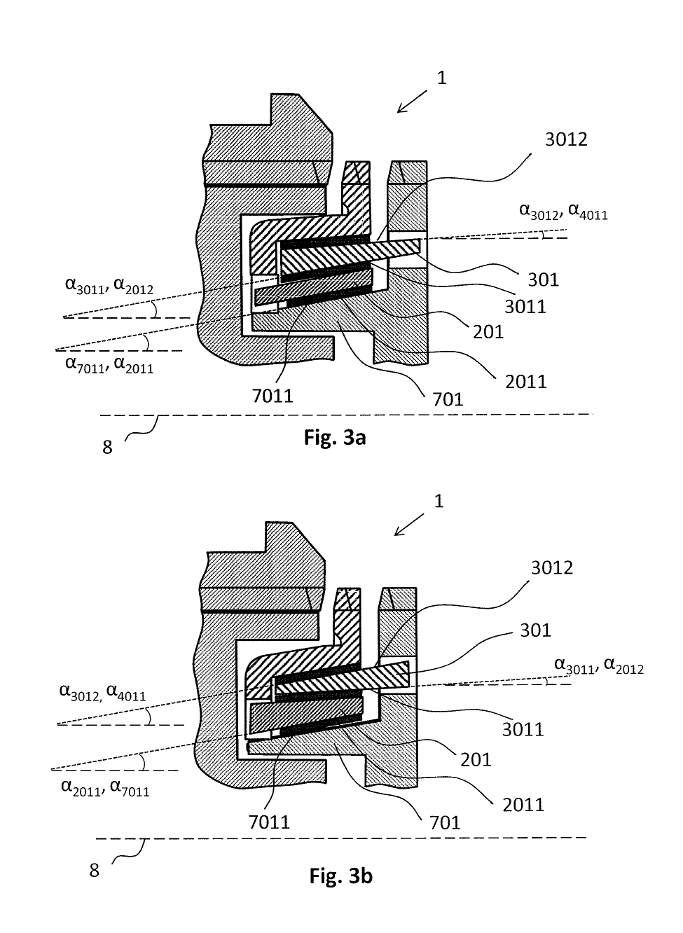

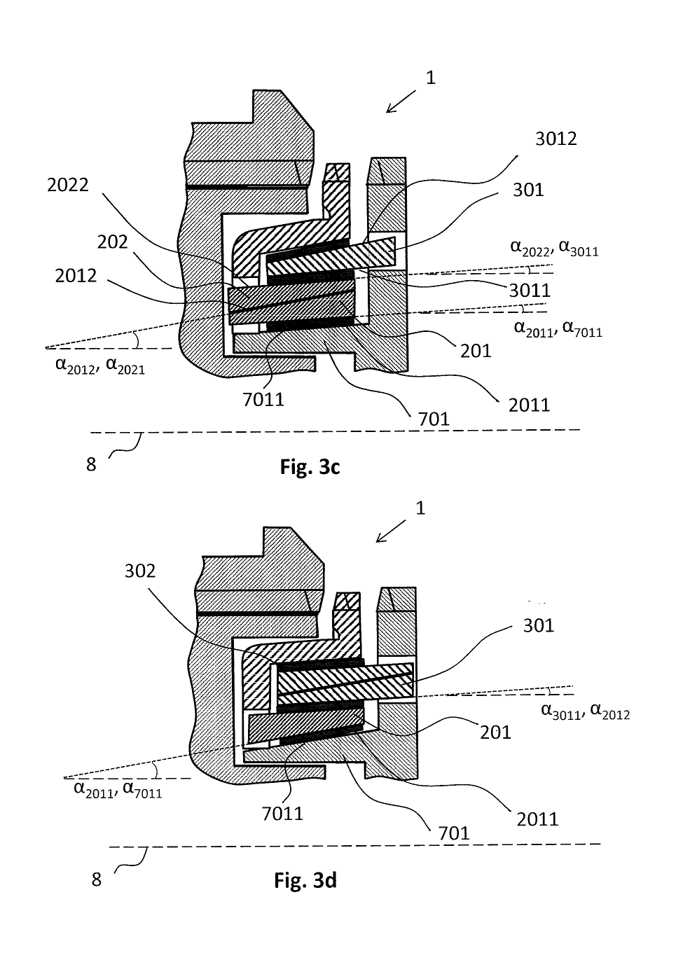

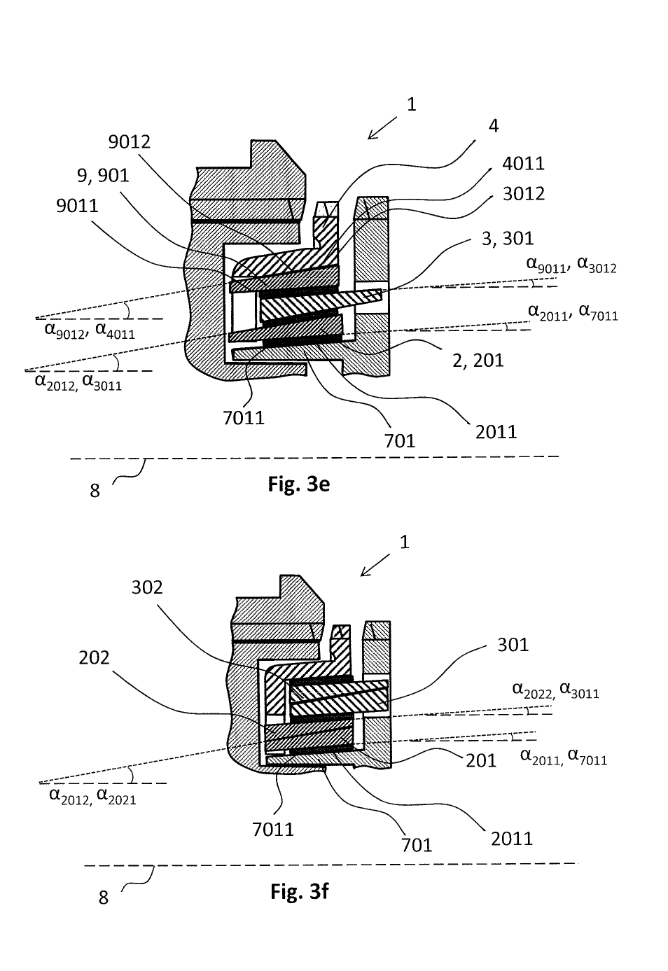

FIGS. 3a-3g show cross-sections of further synchronizing devices 1 according to the invention having three functional friction surfaces.

The gear wheel 7 has a conical gear wheel shoulder 701 in all these synchronizing devices 1, so that a synchronizing moment can be transmitted to the inner synchronizer ring 2 in the operating mode. There the gear wheel shoulder 701 has a gear wheel shoulder surface 7011 extending at a gear wheel shoulder angle α₇₀₁₁ to the ring axis 8.

FIG. 3a shows a cross-section of a first embodiment of a synchronizing device 1 according to the invention with three functional friction surfaces.

As shown in the embodiment according to FIG. 2b, the synchronizing device 1 has a middle synchronizer ring 3, whose first inner angle α₃₀₁₁ of the middle ring is large and whose first outer angle α₃₀₁₂ of the middle ring is small.

In contrast to the embodiment according to FIG. 2b the inner angle α₂₀₁₁ of the inner ring and the outer angle α₂₀₁₂ of the inner ring are the same size, i.e. the inner surface of the inner ring 2011 and the outer surface of the inner ring 2012 are parallel to each other. That is why, in contrast to the embodiment according to FIG. 2b, the inner surface of the inner ring 2011 extends at a large inner angle α₂₀₁₁ of the inner ring, i.e. the inner angle α₂₀₁₁ of the inner ring is not 0°. Thus, the inner angle α₂₀₁₁ of the inner ring corresponds to the gear wheel shoulder angle α₇₀₁₁, so that the inner surface of the inner ring 2011 interacts with the gear wheel shoulder surface 7011 in the operating mode.

The synchronizing device 1 according to FIG. 3a has one friction surface and two friction/loosening surfaces.

FIG. 3b shows a cross-section of a second embodiment of a synchronizing device 1 according to the invention with three functional friction surfaces.

As shown in the embodiment according to FIG. 2a, the synchronizing device 1 has a middle synchronizer ring 3, whose first inner angle α₃₀₁₁ of the middle ring is small and whose first outer angle α₃₀₁₂ of the middle ring is large.

In contrast to the embodiment according to FIG. 2a the inner surface of the inner ring 2011 extends at a large inner angle α₂₀₁₁ of the inner ring, i.e. the inner angle α₂₀₁₁ of the inner ring is not 0°. Thus, the inner angle α₂₀₁₁ of the inner ring corresponds to the gear wheel shoulder angle α₇₀₁₁, so that the inner surface of the inner ring 2011 interacts with the gear wheel shoulder surface 7011 in the operating mode.

As the synchronizing device 1 according to FIG. 3a, the synchronizing device 1 according to FIG. 3b also has one friction surface and two friction/loosening surfaces.

FIG. 3c shows a cross-section of a third embodiment of a synchronizing device 1 according to the invention having three functional friction surfaces.

As shown in the embodiment according to FIG. 3b, the synchronizing device 1 has a middle synchronizer ring 3, whose first inner angle α₃₀₁₁ of the middle ring is small and whose first outer angle α₃₀₁₂ of the middle ring is large.

In contrast to the synchronizing device 1 according to FIG. 3b, the synchronizing device 1 according to FIG. 3c has a two-piece inner synchronizer ring 2, i.e. the inner synchronizer ring 2 is made of a first conical inner ring body 201 and a second conical inner ring body 202.

The first inner ring body 201 has a first inner surface of the inner ring 2011 and a first outer surface of the inner ring 2012, which each bound the first inner ring body 201 in a radial direction extending to the axial ring axis 8, the first inner surface of the inner ring 2011 extending at a first inner angle α₂₀₁₁ of the inner ring and the first outer surface of the inner ring 2012 at a first outer angle α₂₀₁₂ of the inner ring to the ring axis 8. The second inner ring body 202 has a second inner surface of the inner ring 2021 and a second outer surface of the inner ring 2022, which each bound the second inner ring body 202 in a radial direction extending to the axial ring axis 8, the second inner surface of the inner ring 2021 extending at a second inner angle α₂₀₂₁ of the inner ring and the second outer surface of the inner ring 2022 at a second outer angle α₂₀₂₂ of the inner ring to the ring axis 8. Though the second inner angle α₂₀₂₁ of the inner ring corresponds to the first outer angle α₂₀₁₂ of the inner ring and the second outer angle α₂₀₂₂ of the inner ring corresponds to the first inner angle α₂₀₁₁ of the inner ring. The first inner surface of the inner ring 2011 interacts with the gear wheel 7 and the second inner surface of the inner ring 2021 is form-locking connected to the first outer surface of the inner ring 2012 in the operating mode. At the same time the second outer surface of the inner ring 2022 interacts with the first inner surface of the middle ring 3011.

Though the first inner angle α₂₀₁₁ of the inner ring and the gear wheel shoulder angle α₇₀₁₁ are small. At the same time the second outer angle α₂₀₂₂ of the inner ring and the first inner angle α₃₀₁₁ of the middle ring also are small angles.

Thus, the synchronizing device 1 according to FIG. 3c has two friction surfaces, one friction/loosening surface and one loosening surface.

FIG. 3d shows a cross-section of a fourth embodiment of a synchronizing device according to the invention having three functional friction surfaces.

As shown in the embodiment according to FIG. 2c, the middle synchronizer ring 3 has a second middle synchronizer body 302 additional to the first middle synchronizer body 301.

In contrast to the embodiment according to FIG. 2c, the inner surface of the inner ring 2011 extends at a large inner angle α₂₀₁₁ of the inner ring, i.e. the inner angle α₂₀₁₁ of the inner ring is not 0°. The inner angle α₂₀₁₁ of the inner ring corresponds to the gear wheel shoulder angle α₇₀₁₁, so that the inner surface of the inner ring 2011 interacts with the gear wheel shoulder surface in the operating mode.

As the synchronizing device 1 according to FIG. 3c, the synchronizing device 1 according to FIG. 3d also has two friction surfaces, one friction/loosening surface and one loosening surface.

FIG. 3e shows a cross-section of a fifth embodiment of a synchronizing device 1 according to the invention having three functional friction surfaces.

In contrast to the synchronizing devices 1 from FIGS. 3a-3d the synchronizing device 1 according to FIG. 3e has an additional intermediate synchronizer 9 ring with a conical intermediate ring body 901. The intermediate ring body 901 has an inner surface of the intermediate ring 9011 and an outer surface of the intermediate ring 9012, which each bound the intermediate ring body 901 in a radial direction extending to the axial friction ring axis 8. The inner surface of the intermediate ring 9011 extends at an inner angle α₉₀₁₁ of the intermediate ring and the outer surface of the intermediate ring 9012 at an outer angle α₉₀₁₂ of the intermediate ring to the ring axis 8. In this embodiment, the inner angle α₉₀₁₁ of the intermediate ring is small and the outer angle α₉₀₁₂ of the intermediate ring is large. The intermediate synchronizer ring 9 is arranged between the outer synchronizer ring 4 and the middle synchronizer ring 3 and is connected torque proof with the inner synchronizer ring 2 and the synchronizer ring 4 in the operating mode. The inner angle α₉₀₁₁ of the intermediate ring corresponds to the first outer angle α₃₀₁₂ of the middle ring and the outer angle α₉₀₁₂ of the intermediate ring to the inner angle α₄₀₁₁ of the outer ring. Thus, in the operating mode the inner surface of the intermediate ring 9011 interacts with the first outer surface of the middle ring 3012 and the outer surface of the intermediate ring 9012 is form-locking connected, at least partially, to the outer synchronizer ring.

The first inner surface of the inner ring 2011 extends at a small inner angle α₂₀₁₁ of the inner ring. Though the inner angle α₂₀₁₁ of the inner ring corresponds to the gear wheel shoulder angle α₇₀₁₁, so that the inner surface of the inner ring 2011 and the gear wheel shoulder surface 7011 are interacting in the operating mode. At the same time the outer surface of the inner ring 2012 interacting with the first inner surface of the middle ring 3011 in the operating mode is drifting at a large outer angle α₂₀₁₂ of the inner ring.

As the synchronizing device 1 according to FIG. 3c and FIG. 3d, the synchronizing device 1 according to FIG. 3e also has two friction surfaces, one friction/loosening surface and one loosening surface.

FIG. 3f shows a cross-section of a sixth embodiment of a synchronizing device 1 according to the invention having three functional friction surfaces.

As the synchronizing device 1 according to FIG. 2c, the synchronizing device 1 according to FIG. 3f also has a two-piece middle synchronizer ring 3, i.e. the middle synchronizer ring 3 is made of a first conical middle ring body 301 and a second conical middle ring body 302.

In contrast to the synchronizing device 1 according to FIG. 2c the inner synchronizer ring 2 also is designed two-piece. i.e. the inner synchronizer ring 2 comprising a first conical inner ring body 201 and a second conical inner ring body 202, as already described with the the synchronizing device 1 according to FIG. 3c.

The first inner surface of the inner ring 2011 extends at a small inner angle α₂₀₁₁ of the inner ring. Though the first inner angle α₂₀₁₁ of the inner ring corresponds to the gear wheel shoulder angle α₇₀₁₁, so that the first inner surface of the inner ring 2011 and the gear wheel shoulder surface 7011 are interacting in the operating mode. The second outer surface of the inner ring 2022 interacting with the first inner surface of the middle ring 3011 in the operating mode also extends at a small outer angle α₂₀₂₂ of the inner ring.

Thus, the synchronizing device 1 has three friction surfaces and two loosening surfaces.

In all embodiments mentioned above, a friction layer 10 can be provided one-sided and/or two-sided at the surfaces being in contact to each other in the operating mode. It is also possible providing an adhesion reducing surface structure at those surfaces, which do not serve as friction surfaces (loosening surfaces).

Furthermore, in all embodiments described above the first inner ring body 201 and/or the second inner ring body 202 and/or the first middle ring body 301 and/or the second middle ring body 302 and/or the intermediate ring body 901 may have a cutoff in a circumferential direction extending vertical to the axial ring axis 8, wherein the cutoff is open or closed in the non-operating mode.

Finally, in all embodiments described above the first inner ring body 201 and/or the second inner ring body 202 and/or the first middle ring body 301 and/or the second middle ring body 302 and/or the intermediate ring body 901 may have at least one limit stop for fixing in direction to the ring axis 8.

1. Synchronizing device (1) for a gear changing transmission of a motor vehicle, comprising an inner synchronizer ring (2), a middle synchronizer ring (3) and an outer synchronizer ring (4), wherein in an operating mode the outer synchronizer ring (4) and the inner synchronizer ring (2) are connected essentially torque proof with a first shifting element (6), and in the operating mode the middle synchronizer ring (3) is connected essentially torque proof with a second shifting element (7), and whereby the middle synchronizer ring (3) comprises a first conical middle ring body (301) with a first inner surface of the middle ring (3011) and a first outer surface of the middle ring (3012), which each bound the first middle ring body (301) in a radial direction extending to an axial ring axis (8), wherein the first inner surface of the middle ring (3011) extending at a first inner angle (α₃₀₁₁) of the middle ring and the first outer surface of the middle ring (3012) at a first outer angle (α₃₀₁₂) of the middle ring to the ring axis (8), and in the operating mode the first inner surface of the middle ring (3011) is interacting with the inner synchronizer ring (2) and the first outer surface of the middle ring (3012) is directly or indirectly interacting with the outer synchronizer ring (4), characterized in that the first inner angle (α₃₀₁₁) of the middle ring and the first outer angle (α₃₀₁₂) of the middle ring are different.

2. Synchronizing device according to claim 1, wherein the first inner angle (α₃₀₁₁) of the middle ring is smaller than the first outer angle (α₃₀₁₂) of the middle ring.

3. Synchronizing device according to claim 1, wherein the middle synchronizer ring (3) is made of the first conical middle ring body (301) and a second conical middle ring body (302), the second middle ring body (302) comprising a second inner surface of the middle ring (3021) and a second outer surface of the middle ring (3022), which each bound the second middle ring body (302) in a radial direction extending to the axial ring axis (8), wherein the second inner surface of the middle ring (3021) extending at a second inner angle (α₃₀₂₁) of the middle ring and the second outer surface of the middle ring (3022) at a second outer angle (α₃₀₂₂) of the middle ring to the ring axis (8), wherein the second inner angle (α₃₀₂₁) of the middle ring corresponds to the first outer angle (α₃₀₁₂) of the middle ring, and in the operating mode the second inner surface of the middle ring (3021) is form-locking connected, at least partially, to the first outer surface of the middle ring (3012) and the second outer surface of the middle ring (3022) interacts with the outer synchronizer ring (4).

4. Synchronizing device according to claim 1, wherein the inner synchronizer ring (2) is made of a first conical inner ring body (201) and a second conical inner ring body (202), wherein the first inner ring body (201) comprises a first inner surface of the inner ring (2011) and a first outer surface of the inner ring (2012), which bound the first inner ring body (201) in a radial direction extending to the axial ring axis (8), wherein the first inner surface of the inner ring (2011) extending at a first inner angle (α₂₀₁₁) of the inner ring and the first outer surface of the inner ring (2012) at a first outer angle (α₂₀₁₂) of the inner ring to the ring axis (8), and the second inner ring body (202) comprising a second inner surface of the inner ring (2021) and a second outer surface of the inner ring (2022), which each bound the second inner ring body (202) in a radial direction extending to the axial ring axis (8), wherein the second inner surface of the inner ring (2021) extending at a second inner angle (α₂₀₂₁) of the inner ring and the second outer surface of the inner ring (2022) at a second outer angle (α₂₀₂₂) of the inner ring to the ring axis (8), wherein the second inner angle (α₂₀₂₁) of the inner ring corresponds to the first outer angle (α₂₀₁₂) of the inner ring, and in the operating mode the first inner surface of the inner ring (2011) interacts with the second shifting element (7), and the second inner surface of the inner ring (2021) is form-locking connected to the first outer surface of the inner ring (2012) and the second outer surface of the inner ring (2022) interacts with the first inner surface of the middle ring (3011).

5. Synchronizing device according to claim 1, the synchronizing device (1) comprising an intermediate synchronizer ring (9) with a conical intermediate ring body (901), the intermediate ring body (901) comprising an inner surface of the intermediate ring (9011) and an outer surface of the intermediate ring (9012), which each bound the intermediate ring body (901) in a radial direction extending to the axial ring axis (8), wherein the inner surface of the intermediate ring (9011) extending at an inner angle (α₉₀₁₁) of the intermediate ring and the outer surface of the intermediate ring (9012) at an outer angle (α₉₀₁₂) of the intermediate ring to the ring axis (8), wherein in the operating mode the intermediate synchronizer ring (9) is arranged between the outer synchronizer ring (4) and the middle synchronizer ring (3) and is connected torque proof to the inner synchronizer ring (2) and the outer synchronizer ring (4), wherein the inner angle (α₉₀₁₁) of the intermediate ring corresponds to the first outer angle (α₃₀₁₂) of the middle ring and the outer angle (α₉₀₁₂) of the intermediate ring to an inner angle (α₄₀₁₁) of the outer ring, so that in the operating mode the inner surface of the intermediate ring (9011) interacts with the first outer surface of the middle ring (3012), and the outer surface of the intermediate ring (9012) is form-locking connected, at least partially, to the outer synchronizer ring (4).

6. Synchronizing device according to claim 1, wherein the first inner angle (α₂₀₁₁) of the inner ring and/or the first outer angle (α₂₀₁₂) of the inner ring and/or the second outer angle (α₂₀₂₂) of the inner ring and/or the first inner angle (α₃₀₁₁) of the middle ring and/or the first outer angle (α₃₀₁₂) of the middle ring and/or the second outer angle (α₃₀₂₂) of the middle ring and/or the inner angle (α₉₀₁₁) of the intermediate ring and/or the outer angle (α₉₀₁₂) of the intermediate ring is 3-5°.

7. Synchronizing device according to claim 1, wherein the first inner ring body (201) and/or the second inner ring body (202) and/or the first middle ring body (301) and/or the second middle ring body (302) and/or the intermediate ring body (901) has a cutoff in a circumferential direction extending vertical to the axial ring axis (8).

8. Synchronizing device according to claim 7, wherein the cutoff is open or closed in the non-operating mode.

9. Synchronizing device according to claim 1, wherein the first inner ring body (201) and/or the second inner ring body (202) and/or the first middle ring body (301) and/or the second middle ring body (302) and/or the intermediate ring body (901) having at least one limit stop for fixing in direction to the ring axis (8).

10. Synchronizing device according to claim 1, wherein a friction layer, especially a friction layer in the form of a carbon friction layer, is provided at the first inner surface of the inner ring (2011) and/or at the first outer surface of the inner ring (2012) and/or at the second inner surface of the inner ring (2021) and/or at the second outer surface of the inner ring (2022) and/or at the first inner surface of the middle ring (3011) and/or at the first outer surface of the middle ring (3012) and/or at the second inner surface of the middle ring (3021) and/or at the second outer surface of the middle ring (3022) and/or at the inner surface of the intermediate ring (9011) and/or at the outer surface of the intermediate ring (9012).

11. Synchronizing device according to claim 1, wherein an adhesion reducing surface structure is provided at the first inner surface of the inner ring (2011) and/or at the first outer surface of the inner ring (2012) and/or at the second inner surface of the inner ring (2021) and/or at the second outer surface of the inner ring (2022) and/or at the first inner surface of the middle ring (3011) and/or at the first outer surface of the middle ring (3012) and/or at the second inner surface of the middle ring (3021) and/or at the second outer surface of the middle ring (3022) and/or at the inner surface of the intermediate ring (9011) and/or at the outer surface of the intermediate ring (9012).

12. Gear changing transmission for a motor vehicle with a synchronizing device (1) according to claim 1.
